(19) United States
(12) Patent Application Publication
(10) Pub. No.: US 2003/0098212 A1
(43) Pub. Date: May 29, 2003

(54) Hydraulic clutch with a turbine wheel, an impeller wheel and a lockup clutch

(75) Inventors: Christoph Sasse, Schweinfurt (DE); Martin Bremer, Schweinfurt (DE); Bernd Reinhardt, Gera (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/287,051

(22) Filed: Nov. 4, 2002

(30) Foreign Application Priority Data
Nov. 23, 2001 (DE) 101 57 580.7

(51) Int. Cl. F16H 45/02

(52) U.S. Cl. 192/3.29; 192/200

(57) ABSTRACT

An impeller wheel is connected to a housing cover on the drive side so as to be fixed with respect to rotation relative to it. The housing cover has a cover hub. At least one clutch plate of a lockup clutch is coupled to a plate driver and is arranged between the housing cover and a piston which is displaceable axially between an engaged position and a disengaged position. In the engaged position, the clutch plate is coupled with the impeller wheel so as to be fixed with respect to rotation relative to it and in the disengaged position the clutch plate is supported so as to be rotatable relative to the impeller wheel. The piston is supported on the cover hub and is connected to a driver disk so as to be fixed with respect to rotation relative to it, this driver disk being connected to the cover hub so as to be fixed with respect to rotation relative to it. The piston is supported in axial direction at the cover hub in the disengaged position.

### BACKGROUND OF THE INVENTION

1. Field of the Invention

The present invention is directed to a hydraulic clutch with a turbine wheel, an impeller wheel and a lockup clutch, wherein the impeller wheel is connected with a housing cover arranged on the drive side so as to be fixed with respect to rotation relative to it, which housing cover has a cover hub. The lockup clutch has a piston which is displaceable axially between an engaged position and a disengaged position and at least one clutch plate which is coupled to a plate driver and arranged between the piston and the housing cover. The clutch plate is coupled with the impeller wheel so as to be fixed with respect to rotation relative to it in the engaged position of the piston and the clutch plate is supported so as to be rotatable relative to the impeller wheel in the disengaged state of the piston.

2. Description of the Related Art

A hydraulic clutch of the type mentioned above in the form of a torque converter is known, for example, from DE 198 35 549 A1.

### SUMMARY OF THE INVENTION

The hydraulic clutch of the prior art is relatively complicated and requires a relatively large axial installation space. Therefore, it is the object of the present invention to provide a hydraulic clutch which is constructed in a simpler and more economical manner and which requires a smaller installation space—particularly axially—without limiting its performance.

This object is met in that the piston is supported on the cover hub, the piston is connected to a driver disk so as to be fixed with respect to rotation relative to it, this driver disk being connected to the cover hub so as to be fixed with respect to rotation relative to it, and the piston is supported in axial direction at the cover hub in the disengaged position.

As in the prior art, chatter is prevented during idling by the steps according to the invention because the piston is not connected to the transmission input shaft, but rather to the cover hub so as to be fixed with respect to rotation relative to it.

When the cover hub has a stop for the piston and an adjoining hub shoulder by which the driver disk is connected to the cover hub, the clutch can be assembled in a simpler manner and, in particular, the axial installation space can also be further reduced.

When the piston is supported on the cover hub so as to be rotatable, per se, the construction of the hydraulic clutch is even simpler. In particular, the sealing of the piston relative to the cover hub can be achieved in a simpler manner.

When the housing cover bulges outward toward the drive side in its radial central area and the piston has a bulge corresponding to the bulge of the cover, the axial installation space for the hydraulic clutch can be reduced even further.

The driver disk can be connected to the piston, e.g., by a leaf spring arrangement. The leaf spring arrangement preferably connects a radial central area of the piston to a radial outer area of the driver disk.

The leaf spring arrangement is particularly stable when it extends substantially in circumferential direction.

The required axial installation space is reduced even more when the driver disk has a radial inner, substantially radially extending connection area for the cover hub, a radial outer, substantially radially extending connection area for the piston and, therebetween, a radial central, substantially radially and axially extending intermediate area, wherein the radial outer connection area is arranged closer to the drive side than the radial inner connection area.

When a friction facing is arranged between the clutch plate and the piston and between the clutch plate and the housing cover, large torque can be transmitted via the lockup clutch and, further, a slip operation of the lockup clutch is possible.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a partial section through a hydraulic clutch;

FIG. 2 is a partial section of an alternative housing cover; and

FIG. 3 is a section of an alternative embodiment form of a hydraulic clutch.

### DETAILED DESCRIPTION OF THE PRESENTLY PREFERRED EMBODIMENTS

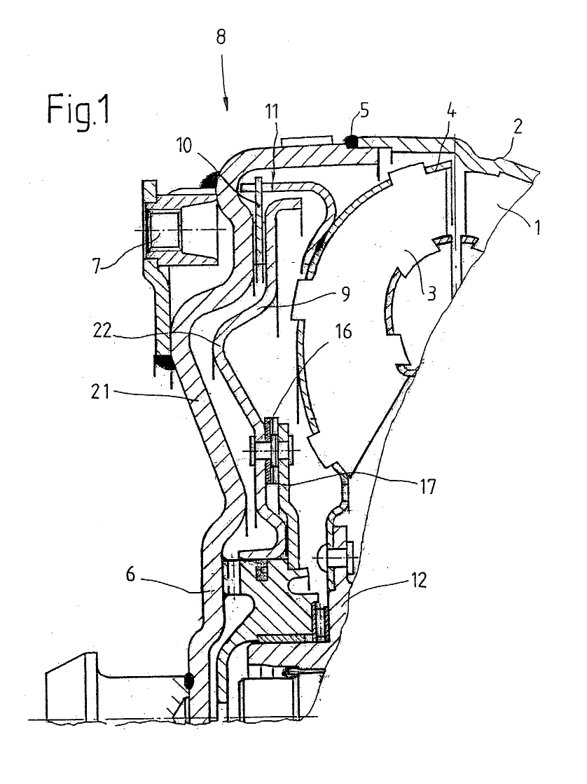

According to FIG. 1, a hydraulic clutch has an impeller wheel 1 with an impeller wheel shell 2 and a turbine wheel 3 with a turbine wheel shell 4. The impeller wheel shell 2 is connected with a housing cover 6—e.g., by a weld connection 5—so as to be fixed with respect to rotation relative to it. The housing cover 6 has fastening elements 7 by which a drive shaft—not shown for the sake of simplicity—can be connected to the housing cover 6, and therefore also to the impeller wheel shell 2, so as to be fixed with respect to rotation relative to it. Accordingly, the housing cover 6 is arranged on the drive side.

The hydraulic clutch can possibly have a stator wheel between the impeller wheel 1 and the turbine wheel 3. If this is the case, the hydraulic clutch is constructed as a torque converter. Otherwise, it is a simple hydraulic clutch without torque conversion.

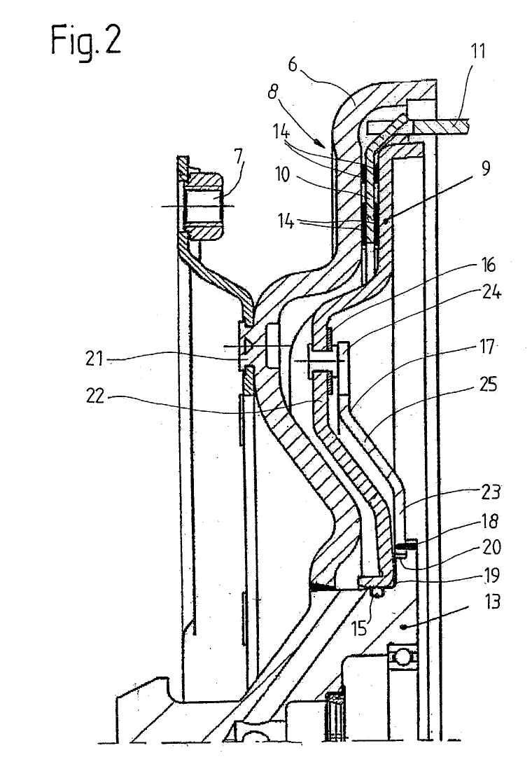

As can be seen particularly clearly from FIG. 2, the hydraulic clutch has a lockup clutch 8. The lockup clutch 8 has a piston 9 and (at least) one clutch plate 10.

The clutch plate 10 is arranged between the housing cover 6 and the piston 9. It is coupled with a plate driver 11. The plate driver 11—see FIG. 1—is connected with the turbine wheel shell 4, and therefore also with a turbine wheel hub 12, so as to be fixed with respect to rotation relative to it. However, it is also possible that the plate driver 11 is connected to the turbine wheel hub 12 in such a way that it is rotatable by a limited angle of rotation relative to the turbine wheel hub 12.

As can be seen in FIG. 2, the housing cover 6 has a cover hub 13. The piston 9 is supported on this cover hub 13 so as to be axially displaceable. Accordingly, it is axially displaceable between two positions, namely, an engaged position and a disengaged position.

In the engaged position of the piston 9, the clutch plate 10 is connected to the housing cover 6 and to the piston 9 in a nonpositive or frictional engagement. Also, in the engaged position of the piston 9, the plate driver 11 is accordingly coupled with the impeller wheel 1 so as to be fixed with respect to rotation relative to it. Friction facings 14 are arranged at the clutch plate 10 facing the housing cover 6 and facing the piston 9. Accordingly, large torque can be transferred via the lockup clutch 8 and, at the same time, the lockup clutch 8 has a long life.

In the disengaged position of the piston 9, the clutch plate 10—and therefore also the plate carrier 11—is supported so as to be rotatable relative to the impeller wheel 1. In this case, the torque flow is carried out directly from the impeller wheel 1 to the turbine wheel 3.

The piston 9 is supported on the cover hub 13 so as to be rotatable, per se. Accordingly, a sealing of the piston 9 relative to the cover hub 13 is achieved in a simple manner particularly by means of a conventional seal element 15. However, the piston 9 would be rotatable relative to the housing cover 6 without any further steps. In particular, in slip operation of the lockup clutch 8, there could be an uncontrolled slipping of the piston 9 relative to the housing cover 6.

In order to prevent such slipping, the piston 9 is connected, via a leaf spring arrangement 16, to a driver disk 17 so as to be fixed with respect to rotation relative to it. The driver disk 17 is connected in turn—e.g., by a weld 18—to the cover hub 13 so as to be fixed with respect to rotation relative to it. As is shown in FIG. 2, the leaf spring arrangement 16 extends substantially in circumferential direction. It connects a radial central area of the piston 9 to a radial outer area of the driver disk 17.

Forces act on the piston 9 in the engaged position and in the disengaged position. In particular, the piston 9 is supported at the cover hub 13 in axial direction in the disengaged position. For this purpose, the cover hub 13 has a stop 19. Axial forces are accordingly prevented from acting on the driver disk 17.

According to FIGS. 1 and 2, the cover hub 13 is connected to the driver disk 17, e.g., by means of a hub shoulder 20.

In its radial central area, the housing cover 6 has a bulge 21 directed to the drive side. The piston 9 has a corresponding bulge 22. The driver disk 17 has a radial inner connection area 23, a radial outer connection area 24 and an intermediate area 25. The radial inner connection area 23 extends substantially radial to the cover hub 13 and is connected with it. The radial outer connection area 24 likewise extends substantially radially, but towards the piston 9. As can be seen, it is arranged closer to the drive side than the radial inner connection area 23. The intermediate area 25 accordingly extends substantially radially as well as axially between the two connection areas 23, 24.

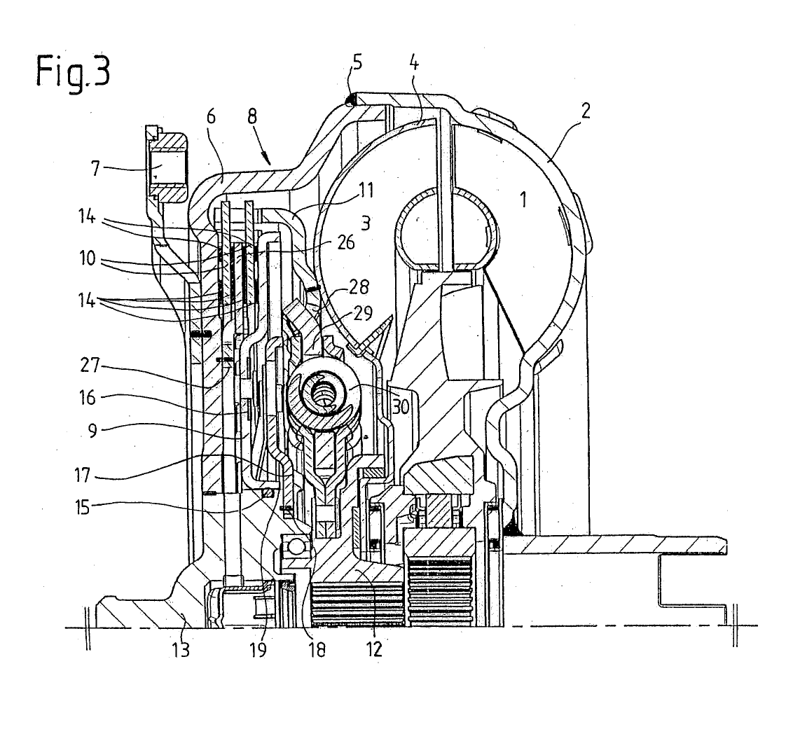

In the embodiment form according to FIGS. 1 and 2, a lockup clutch 8 with an individual clutch plate 10 is connected to the turbine wheel hub 12 directly, that is, without the intermediary of a torsional vibration damper. However, the hydraulic clutch can also have more than one clutch plate 10 and/or a torsional vibration damper. A construction of this type is shown in FIG. 3. The two steps can accordingly be implemented independently.

According to FIG. 3, the lockup clutch 8 has an intermediate plate 26 which is connected, e.g., by welding, by an intermediate web 27 to the housing cover 6 so as to be fixed with respect to rotation relative to it. Two clutch plates 10 are coupled with the plate driver 11. One clutch plate 10 is arranged between the housing cover 6 and the intermediate plate 26 and the other clutch plate 10 is arranged between the piston 9 and the intermediate plate 26. The clutch plates 10 are provided with friction facings 14 on both sides, so that an even greater torque can be transmitted via the lockup clutch 8.

Further, it can be seen that while the plate driver 11 is again connected (by welding, in this case) to the turbine wheel shell 4 so as to be fixed with respect to rotation relative to it, the plate driver 11 acts on a torsional vibration damper 30 directly or—as shown in FIG. 3—via a toothing 28 and an intermediate element 29. Due to the fact that the torsional vibration damper 30 is connected to the turbine wheel hub 12 so as to be fixed with respect to rotation relative to it, the turbine wheel shell 4 is supported so as to be rotatable relative to the turbine wheel hub 12. Accordingly, in the embodiment form according to FIG. 3, the torsional vibration damper 30 acts as a turbine torsional vibration damper 30. In principle, however, it is also possible for the torque flow to be guided via the torsional vibration damper 30 only when the piston 9 is located in its engaged position, that is, when the lockup clutch 8 is closed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A hydraulic clutch comprising:
a turbine wheel to which a plate driver is fixed;
an impeller wheel;
a housing cover arranged on a drive side and having a cover hub, said impeller wheel being fixed against rotation relative to said housing cover;
a lock-up clutch comprising a piston supported on said cover hub and displaceable axially between an engaged position and a disengaged position, said piston being axially supported at the cover hub in the disengaged position, and at least one clutch plate arranged between the piston and the housing cover and coupled to said plate driver; and
a driver disk to which said piston is fixed against rotation, said driver disk being fixed against rotation to said cover hub.

2. A hydraulic clutch as in claim 1 wherein said cover hub comprises an axial stop for said piston, and a shoulder where said driver disk is fixed to said cover hub.

3. A hydrodynamic clutch as in claim 1 wherein said piston is rotatable with respect to said cover hub.

4. A hydraulic clutch as in claim 1 wherein said housing cover has a radial central area having a bulge facing said drive side, said piston having a bulge corresponding to said bulge in said housing cover.

5. A hydraulic clutch as in claim 4 further comprising a leaf spring arrangement connecting said piston to said driver disk.

6. A hydraulic clutch as in claim 5 wherein said leaf spring arrangement connects a radial central area of the piston to a radial outer area of the drive disk.

7. A hydraulic clutch as in claim 5 wherein said leaf spring arrangement extends substantially circumferentially.

8. A hydraulic clutch as in claim 1 wherein said driver disk has a substantially radially extending radial inner connection area connected to said cover hub, a substantially radially extending outer connection area connected to said piston, and a substantially radially and axially extending intermediate area, whereby said outer connection area is closer to the drive side than said inner connection area.

9. A hydraulic clutch as in claim 1 further comprising a friction facing arranged between the clutch plate and the piston, and a friction facing arranged between the clutch plate and the housing cover.
